(19) United States
(12) Patent Application Publication
(10) Pub. No.: US 2021/0272026 A1
(43) Pub. Date: Sep. 2, 2021

(54) SYSTEM AND METHODS FOR TICKET TRANSACTIONS

(71) Applicant: Daniel Marcus, New York, NY (US)

(72) Inventor: Daniel Marcus, New York, NY (US)

(21) Appl. No.: 16/804,501

(22) Filed: Feb. 28, 2020

(51) Int. Cl. G06Q 10/02; G06Q 20/32

(52) U.S. Cl. CPC G06Q 10/02; G06Q 20/325

(57) ABSTRACT

A method, computer program product and a system for receiving information corresponding to an event ticket, determining a value of the event ticket, publishing at least a portion of the information corresponding to the event ticket and the value of the event ticket, receiving an offer for the event ticket and providing the offer to a current owner of the event ticket.

### FIELD OF INVENTION

The exemplary embodiments provide a system and methods for conducting ticket transactions via the online internet.

### BACKGROUND

Computer systems and networks have facilitated the tasks of purchasing and selling event ticket sales. For example, global computer networks, such as the internet, have allowed purchasers to relatively quickly and efficiently seek and purchase ticketed goods online. Such computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistical tasks. For these reasons, sellers actively use the internet to offer, sell and distribute a wide variety of goods to take advantage of the many benefits provided by the Internet and electronic commerce.

Certain electronic commerce companies provide a network-based system which implement an online ticket marketplace for buyers and sellers of tickets for live events such as sports, concerts, theater, and other entertainment events. These companies may enable legitimate, convenient, reliable, and secure transactions at fair market value.

A common challenge that occurs among sports franchises performing at poor levels is that the percentage of game attendees who are fans of the opposing team tends to creep up over time. This can result in a negative public image for the franchise, increased apathy by fans, and a dip in season ticket subscription sales.

Another challenge which exists for ticket seekers is that the majority of electronic commerce companies facilitate ticket transactions only for currency. This limits customer choice if, for example, a customer is interested in exchanging their ticket or making a partial payment in currency in addition to a ticket exchange.

There exists a need to facilitate the task of ticket transaction which addresses both the need for sustaining fan attendance for poor performing teams and a system which offers obtaining tickets through a diverse offering.

The following disclosure and attached drawings describe examples of some embodiments of the invention. The designs, figures, and description are non-limiting examples. Other embodiments of the system and methods may or may not include the features disclosed herein.

### SUMMARY

Some exemplary embodiments include a method or a computer program product for receiving information corresponding to an event ticket, determining a value of the event ticket, publishing at least a portion of the information corresponding to the event ticket and the value of the event ticket, receiving an offer for the event ticket and providing the offer to a current owner of the event ticket.

Other exemplary embodiments include a system having a memory storing information corresponding to an event and event tickets for the event and a processor configured to receive information corresponding to one of the event tickets, determine a value of the one of the event tickets, publish at least a portion of the information corresponding to the one of the event tickets and the value of the one of the event tickets, receive an offer for the one of the event tickets and provide the offer to a current owner of the one of the event tickets.

### BRIEF DESCRIPTION OF THE DRAWINGS

While the attached drawings show, describe and point out novel features as applied to various embodiments, it will be understood that various omissions, substitutions, and changes in the form and details of the system and methods may be made without departing from the spirit of the disclosure. As will be recognized, certain embodiments described herein may be embodied within a form that does not provide all of the features and benefits set forth herein, as some features may be used or practiced separately from others.

FIG. 1 illustrates an exemplary system for performing ticket transactions according to various embodiments described herein.

FIG. 2 illustrates a flow chart of an example method for a ticket holder to input details of tickets to be transacted and using the system's automated value range to make decisions about whether to move forward towards a transaction.

FIG. 3 illustrates a flow chart of an example method for a ticket holder and a user who desire's tickets to make decisions once the ticket(s) has been published onto the system.

FIG. 4 illustrates a flow chart of an example method once a user makes an offer for the ticket, or tickets.

FIG. 5 illustrates a flow chart of an example method once a ticket holder makes a counter-offer to user who desire's tickets.

### DETAILED DESCRIPTION

The particulars shown herein are by way of example and for purposes of illustrative discussion of the invention only and are presented to provide what is believed to be the most useful and readily understood description of the principles and conceptual aspects of the invention. It will nevertheless be understood that the scope of the invention disclosure includes equivalents not particularized herein but nonetheless enabled by the instant specification or would be known to skilled artisans.

Various aspects described or referenced herein are directed to different methods, systems, and computer program products relating to facilitating ticketing transactions.

Throughout this description the term “user” is used to describe a user of the exemplary system. It should be understood that a “user” may refer to a person who currently has tickets and is looking to sell, swap or perform some other transaction regarding the tickets that the person currently holds. In some instances, this type of “user” may be referred to as a “ticket holding user.” It should also be understood that the term “user” may also refer to a person that does not currently hold a ticket for an event but desires a ticket to the event. In some instances, this type of “user” may be referred to as a “non-ticket holding user.” The exemplary system may facilitate transactions between a ticket holding user” and a non-ticket holding user or between two ticket holding users (e.g., a ticket swap). The exemplary system may also facilitate transactions between a ticket holding user and the system itself, e.g., the owner and/or operator of the system may purchase tickets from ticket holding users to keep an inventory of tickets for various events. In addition, it should be understood that while the exemplary transactions described herein are between two parties, the principles described herein may be used to facilitate multi-party transactions where three or more parties are involved.

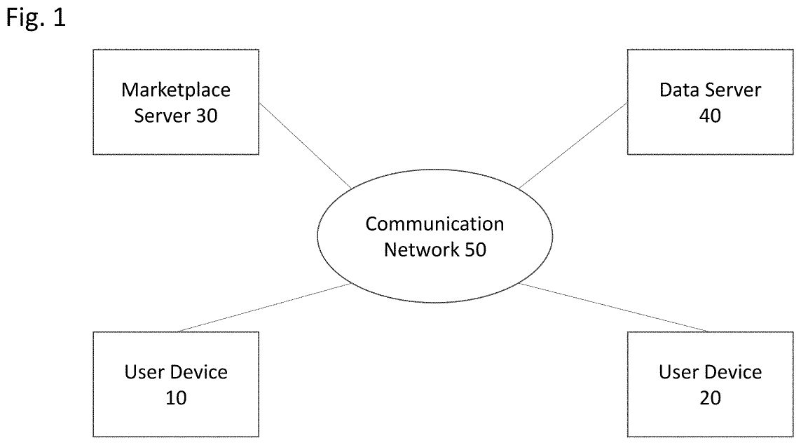

FIG. 1 illustrates an exemplary system for performing ticket transactions according to various embodiments described herein. The system and methods utilize various elements of a communications system from one or more user devices having computing and/or communications capabilities in accordance with the described embodiments. In the exemplary system of FIG. 1, a first user device 10, a second user device 20, a marketplace server 30 and a data server 40 are illustrated. Each of these devices 10-40 may communicate with each other via a communications network 50. Each of these components will be described in greater detail below. It should be understood that the use of two user devices, two server devices and a single communication network is only exemplary, and the exemplary embodiments may be implemented in systems having any number of components and communications networks.

The exemplary user devices 10, 20 may include a processor, memory, and network communication capabilities. The user devices 10, 20 may be configured for communication with one or more other components via the communication network 50. Some examples of the user devices 10, 20 include a laptop computer, a desktop computer, a tablet computer, a smartphone, a personal digital assistant (“PDA”), a mobile e-mail device, a portable game player, smart wearable technology, an internet of things (“IoT”) device or any other applicable electronic device capable of accessing the communication network 50.

The exemplary user devices 10, 20 may implement various hardware and/or software components in accordance with the described embodiments. Exemplary hardware components may include processing devices such as central processing unit (CPU) and/or other processors, microprocessors, application processors, radio processors, baseband processors, digital signal processors (DSP), circuits, circuit elements (e.g., transistors, resistors, capacitors, inductors, and so forth), integrated circuits, application specific integrated circuits (ASIC), programmable logic devices (PLD), a field programmable gate array (FPGA), logic gates, registers, semiconductor device, chips, microchips, chip sets, memory such as volatile and/or non-volatile memory, a display such as a liquid crystal display (LCD) or cathode ray tube (CRT), input devices such a keyboard, mouse, stylus, touch pad, and/or touch screen, networking devices such as ports, network interface cards (NICs), transmitters, receivers, transceivers, and/or antennas, as well as other components. Exemplary software components may include computer programs, applications, application programs, system programs, operating system (OS) software, middleware, firmware, a software interface, a programmatic interface, an application program interfaces (API), a network interface, a web interface, a messaging interface, modules, instruction sets, routines, subroutines, functions, calls, computing code, or combination thereof.

The exemplary servers 30, 40 may include a processor, memory, and network communication capabilities. The servers 30, 40 may be configured for communication with one or more other components via the communication network 50. The servers 30, 40 may include a web server, an API server, and a messaging server that provide interfaces to applications hosted by the servers 30, 40. The applications may be structured, arranged, and/or configured to provide various online marketplace and/or ticket fulfillment services to users that access the network-based system. It is also noted that the servers 30, 40 may be implemented as cloud based services or virtual servers.

For example, the user devices 10, 20 may communicate with the applications hosted by the servers 30, 40 via one or more of a web interface provided by the web server, a programmatic interface provided by the API server, and a messaging interface provided by the messaging server. It can be appreciated that the web server, the API server, and the messaging server may be structured, arranged, and/or configured to communicate with various types of client devices and/or client programs and may interoperate with each other in some implementations.

The web server may be arranged to host web pages (e.g., HTML documents) and provide an appropriate web interface (e.g., HTTP, CGI, etc.) for enabling data to be presented to and received from entities via the Internet. The web server may be arranged to communicate with web clients and/or applications such as a web browser, web browser toolbar, desktop widget, mobile widget, web-based application, web-based interpreter, virtual machine, and so forth. The web server may provide a web interface to enable access by the client and/or the third party to the various services and functions provided by the application servers. For example, the web server may be arranged to receive data from the client and/or third party and to pass the data to one or more application servers within the network-based system. The web server also may present the client and/or third party with relevant static and dynamic content hosted by the network-based system in response to various requests and/or events.

The API server may be arranged to communicate with various client programs and/or a third-party application (e.g., third-party web site) comprising an implementation of API for the network-based system. The API server may provide a programmatic interface to enable access by the client and/or the third party to the various services and functions provided by the application servers. For example, the programmatic interface provided by the API server may be used for batch-mode and/or real-time communication with a high-volume seller for receiving and updating inventory listings. The programmatic interface provided by the API server also may be used to communicate relevant static or dynamic content hosted by the network-based system to an API implementation of one or more client programs and/or a third-party application (e.g., third-party web site). The API implementation may comprise, for example, executable code in accordance with a software development kit (SDK) provided by the network-based system.

The communication network 50 may include the hardware and/or software to support wired and/or wireless communications functionality in accordance with the described embodiments. For example, some computing devices may be arranged to communicate information over one or more types of communication links such as a wire, cable, bus, printed circuit board (PCB), backplane, switch fabric, semiconductor material, twisted-pair wire, co-axial cable, fiber optic connection, Ethernet connection, peer-to-peer (P2P) connection, a data channel, a radio channel, a satellite channel, a television channel, a broadcast channel, an infrared (IR) channel, a radio-frequency (RF) channel, a portion of the RF spectrum, 4G, 5G, one or more licensed or license-free frequency bands, and so forth.

Various elements of the communications system may support communication over one or more types of networks in accordance with the described embodiments. For example, some computing devices and networks may support communications over a Wide Area Network (WAN), the Internet, a telephone network, a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1×RTT, GSM/GPRS, EDGE, HSDPA, HSDPA, and others.

Computing devices and networks may support wireless local area network (WEAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. Computing devices and networks also may support short range communication such as a wireless personal area network (WPAN) communication, Bluetooth® data communication, infrared (IR) communication, near-field communication, electro-magnetic induction (EMI) communication, passive or active RFID communication, micro-impulse radar (MIR), ultra-wide band (UWB) communication, automatic identification and data capture (AIDC) communication, and others.

The communications system includes, among other elements, a client which may comprise or employ one or more client devices such as a mobile computing device, a PC, and/or any other computing device having computing and/or communications capabilities in accordance with the described embodiments. The client devices generally may provide one or more client programs such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. In some usage scenarios, one or more of the client programs may display various graphical user interfaces (GUIs) to present information to and/or receive information from one or more of the client devices.

The client may be communicatively coupled via one or more networks to a network-based system. The network-based system may be structured, arranged, and/or configured to allow the client to establish one or more communications sessions with the network-based system using various computing devices and/or client programs. Accordingly, a communications session between the client and the network-based system may involve the unidirectional and/or bidirectional exchange of information and may occur over one or more types of networks depending on the mode of communication. While in certain embodiments a communications system may be deployed in a client-server operating environment, it is to be understood that other suitable operating environments and/or architectures may be used in accordance with the described embodiments.

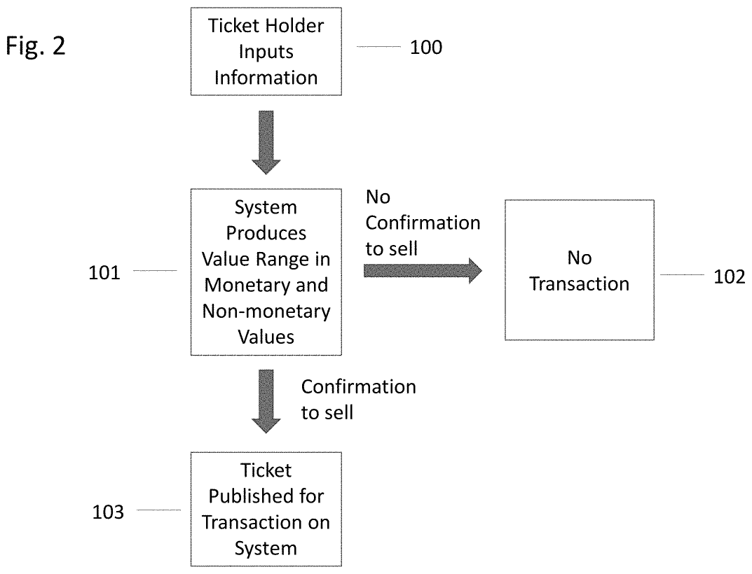

FIG. 2 illustrates a flow chart of an example method of a ticket holder to input details of tickets to be transacted and using the system's automated value range to make decisions about whether to move forward towards a transaction. The method of FIG. 2 will be described with reference to the exemplary system of FIG. 1. In this example, it may be considered that the user device 10 is associated with a registered ticket holder user that currently has tickets to an event. It may also be considered that the user device 20 is associated with another registered user (ticket holding user or non-ticket holding user) that may desire to enter a transaction with the ticket holding user associated with user device 10. It may further be considered that the marketplace server 30 is the device that implements the functionality associated with hosting the exemplary transactions described herein. Finally, the data server 40 may be considered the device that includes additional information used for the purposes of retrieving information related to the transaction. For example, in the below description, the server 40 may include the information related to the event tickets currently owned by the user and the secondary market for the event tickets.

In this example, in 100, a registered user using user device 10 may input event details into a ticketing application being executed on the user device 10. These event details may be communicated via the communication network 50 to the marketplace server 30. Entry of the event details may be performed by manual input or by scanning a ticket for automatic input of ticket details. In another example, the marketplace server 30 may include details for various ticketed events and the registered user may be able to select a ticket and have the details automatically entered or retrieved. Such details may include the titled event, ticket number, date, seat location, etc.

Once the details are received by the marketplace server 30, in 101, the marketplace server 30 may then determine an estimated value for the offered ticket, or tickets and provide this information back to the user device 10. The information may be provided via a user interface of the ticketing application or may be sent in other manners, e.g., email, text, etc.

The estimated value determined by the marketplace server 30 may include an estimated monetary value and/or non-monetary value for ticket appraisal. In certain embodiments, transactions may include monetary payment. In certain embodiments, transactions may include a non-monetary value. The non-monetary value may include, for example, proprietary points or other manner of valuing tickets such as a swap value. In certain embodiments, transactions may include both monetary payment and non-monetary value. Each of these manners of valuing tickets will be described in more detail below.

For monetary estimates, the marketplace server 30 system may ingest real-time secondary market data including for example, the high price, the low price, the average price, the amount of tickets listed on the secondary market for a particular event, the location of the available tickets, etc., to provide a distribution of ticket prices for that event and an estimated monetary value for the ticket(s). As described above, in this example, this secondary market data may be ingested from the data server 40. The estimated monetary value may guide the ticket holder's appraisal of the value of their ticket(s) in addition to providing a recommendation for their requested price. In one exemplary embodiment, the system may remove the highest 25% of secondary market ticket prices for a given event, seat or seat area and then apply a re-distributed listing where the tickets listed for sale cluster towards a lower average. With this proprietary distribution, system users may be provided cost effective pricing targets. The user may optionally use this re-distributed listing information to assign a value to their ticket(s). Both the pricing distribution and assigned value may be displayed for an interested user to compare the value while engaging in a transaction. It should be understood that the removal of the highest 25% of secondary market tickets is only exemplary and other algorithms for determining an effective pricing target may also be used.

In further exemplary embodiments, system features allow users to make transactions using non-monetary proprietary points. In such embodiments, the system allows a ticket offer to be made in terms of proprietary points. Proprietary points may be used, in turn, by the ticket holder to purchase future tickets being offered within the system. Once proprietary points are obtained, they may be redeemed within the system for future events. In determining a proprietary point value, the system may consider one or more of the following: 1) the amount of time left before the event starts; 2) the amount of activity or interest other users have expressed in acquiring those tickets; and 3) the price distribution across the secondary market for the event.

In a further exemplary embodiment, the system may determine a swap value for the user's ticket(s). The swap value may be determined using the same or different factors described above for the monetary value and/or proprietary points. In the example of swap value, the user may be provided with a corresponding event/seat location/number of ticket(s) that approximately correspond to their current tickets. To provide a specific non-limiting example, the user may currently have two tickets to a Taylor Swift concert. These two tickets may correspond to two tickets in the same section to a Rolling Stones concert, for tickets in a different section to a Chemical Brothers concert, for the same tickets on a different night to Taylor Swift, etc. In another example, the swap value of the ticket may correspond to a point value that can be used to swap for other tickets having a corresponding swap value. This information about available swap value may be provided to the ticket holding user.

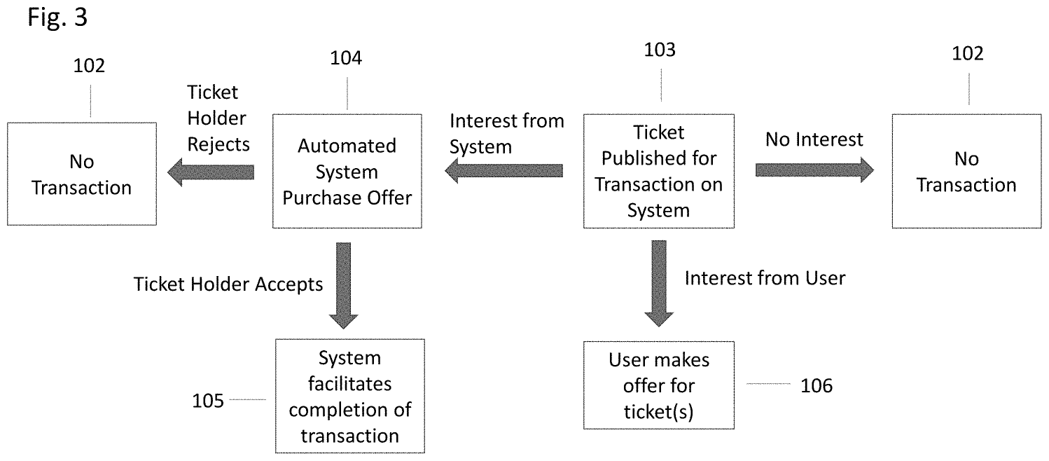

Once the system provides an estimated value range for the ticket(s), the ticket holding user may use the system generated estimated value in deciding whether to either confirm or not confirm publishing an offer to transact for the ticket(s). Such confirmation may be made by clicking on an appropriate box or link within the system. Not providing confirmation results in no transaction 102. Alternatively, providing confirmation results in the ticket, or tickets, being published 103 onto the system as an offer for transacting. In certain embodiments, the ticket owner publishes the ticket information on the system along with a requested value to their ticket(s) such that other users have a mechanism to compare the value when considering a transaction. In other embodiments, the ticket owner publishes the ticket information using a monetary and/or non-monetary threshold of their choosing. Additional exemplary operations resulting from the tickets being published 103 will be provided below with reference to FIG. 3.

Once confirmed that the ticket holding user intends to enter a transaction regarding their ticket(s), the ticket holding user may then either upload electronic tickets to the system inventory, or if the tickets are in the form of hard copies, the system may arrange for physical delivery to the acquiring user. In such a physical embodiment, confirmation of intent to transact regarding the ticket(s) may be done by clicking on an acceptance link embedded within the system.

When the user has confirmed the intent to sell or swap a ticket, or tickets, exemplary embodiments of the system allow registered users to search the system for tickets to events of interest. For example, another user associated with user device 20 may search for tickets via an application on user device 20 that communicates with the marketplace server 30 to show events of interest. Users may be able to search for such categories as event type, performer/team, date, location and other categories. In certain embodiments, the system may propose matches based upon a matching algorithm that considers variables such as favorite teams or performers, location, or past activity on the platform. For example, the marketplace server 30 or data server 40 may store a user profile for each registered user. The information from this user profile may be used to propose various matching events. In certain embodiments, users may also be able to find event tickets by discovering other users who have similar profile information, such as whether the user is a season ticket holder to a particular sports franchise, how many transactions that user has successfully completed, etc.

In further exemplary embodiments, system features allow for identification and matching of fans based upon their team allegiances. The system accomplishes this by using a weighted formula that considers variables such as the number of events that a fan of a particular team has attended, engagement with other users on the platform, cross-referencing season ticket account holder numbers against known account numbers, and other users of the platform identifying and vouching for the user as an avid genuine fan of the team in question. The system may allow only users that meet a threshold avidity score based upon the weighted formula being matched with sellers who have indicated that non-opposing fan sits in his or her seats is a priority. Users who designate that transacting tickets with a genuine fan of the same team is a priority may then be shown a list of non-opposing team users that they may choose to transact with.

FIG. 3 illustrates a flow chart of an example method for a ticket holding user and a user who desire's tickets to make decisions once the ticket(s) has been published onto the system. The ticket transactions may include peer-to-peer ticket transactions or automated offers for ticket(s). For example, after the ticket is published 103 for a transaction on the system, the system may also create an automated offer for ticket(s) 104. The system itself may have interest in transacting for tickets (e.g., for the purposes of having a ticket inventory) and may make an offer. The ticket holder may then reject the offer resulting in no transaction 102. Alternatively, the ticket holder may accept the offer resulting in completion of the transaction 105, which steps are facilitated by the system. The completion of the transaction 105 may include credit card processing, indicating the ticket(s) now belong to a different user, sending electronic tickets to the person or entity that now owns the tickets (e.g., via email, text, an application, etc.), depositing money and/or points into a user's account, etc.

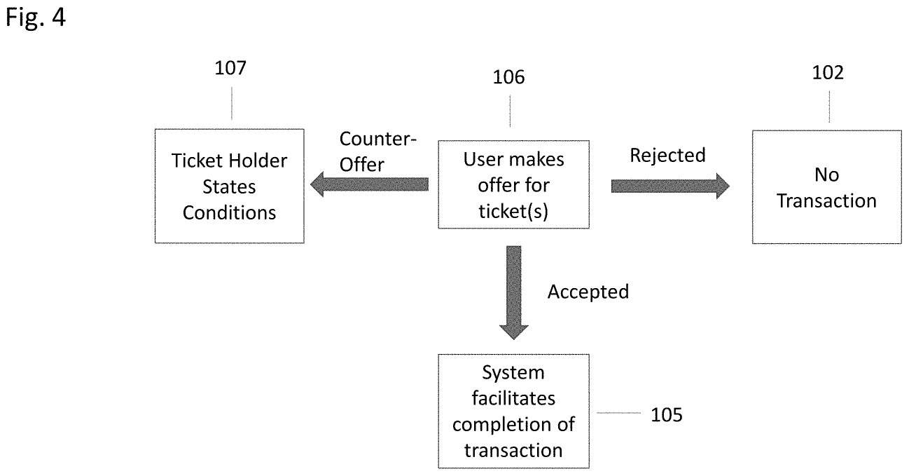

In an exemplary peer-to-peer type transaction, a user may find ticket(s) of interest and propose an offer 106 encompassing either a monetary purchase, a ticket for ticket barter transaction, or a ticket for ticket combined with either a set amount of currency or proprietary non-monetary points. Additional exemplary operations resulting from the proposed offer 106 will be provided below with reference to FIG. 4.

FIG. 4 illustrates a flow chart of an example method once a user makes an offer for the ticket, or tickets. Once a user makes an offer 106 for the ticket(s), the ticket holding user may either accept, reject, or make a counter-offer. The ticket holder rejecting the offer results in no transaction 102. If ticket holder accepts the offer 106, this results in completion of the transaction 105, which steps are facilitated by the system. Once a transaction is accepted, the system may automatically send each user the tickets they transacted for and also seamlessly deposit any currency included in the transaction into the system-based account of the user expecting such currency.

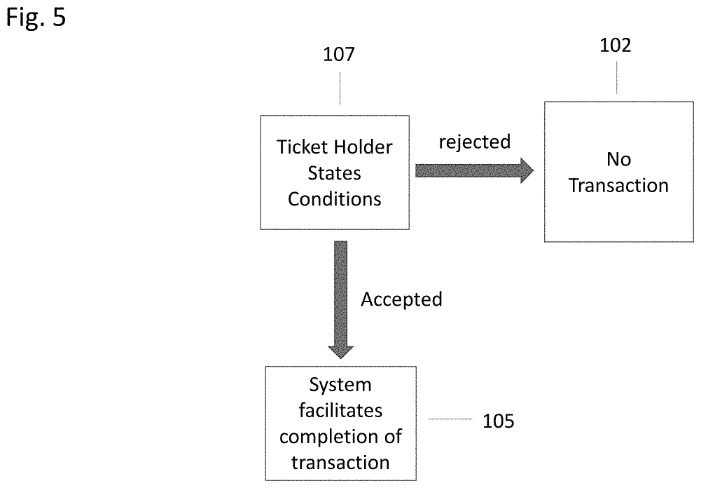

Alternatively, the ticket owner may make a counter-offer 107 with their stated conditions for transaction completion. The counter-offer may request a trade for another ticket which the other user may have published onto the system, currency, proprietary non-monetary points, or a combination thereof. Additional exemplary operations resulting from the counter-offer 107 will be provided below with reference to FIG. 5.

FIG. 5 illustrates a flow chart of an example method once a ticket holding user a counter-offer 107 to a user who desires the published tickets. The interested user may either accept or reject the ticket holding user's stated conditions within the counter-offer 107. The user rejecting the counter-offer results in no transaction 102. If the user accepts the offer, this results in completion of the transaction 105, which steps are facilitated by the system.

The foregoing description has been presented only for purposes of illustration and description. This description is not intended to limit the invention to the precise form disclosed. It is intended that the scope of the invention be defined by the claims appended hereto.

1. A method, comprising:
receiving information corresponding to an event ticket;
determining a value of the event ticket;
publishing at least a portion of the information corresponding to the event ticket and the value of the event ticket;
receiving an offer for the event ticket; and
providing the offer to a current owner of the event ticket.

2. The method of claim 1, further comprising:
completing a transaction for the event ticket based on the offer.

3. The method of claim 1, wherein the offer is received from one of another user or from a system that determines the value of the event ticket.

4. The method of claim 1, further comprising:
providing the value of the event ticket to the current owner of the event ticket prior to publishing the at least the portion of the information corresponding to the event ticket and the value of the event ticket.

5. The method of claim 4, further comprising:
receiving one of (i) a confirmation from the current owner that the at least the portion of the information corresponding to the event ticket and the value of the event ticket is to be published or (ii) a different value that is to be published for the event ticket.

6. The method of claim 1, further comprising:
receiving, from the current owner of the event ticket, a counter-offer for the event ticket;
providing, to a user that made the offer, the counter-offer; and
completing a transaction for the event ticket based on the counter-offer.

7. The method of claim 1, wherein the value includes one of a monetary value, a ticket swap value or a point value.

8. The method of claim 1, wherein determining the value of the event ticket is based on at least price information from a secondary marketplace.

9. The method of claim 1, wherein the information includes one of an indication of an event corresponding to the event ticket, a date of the event, a time of the event, a face value of the event ticket, a seat number corresponding to the event ticket, or a section number corresponding to the event ticket.

10. The method of claim 1, further comprising:
providing profile information about a user that made the offer to the current owner of the event ticket.

11. The method of claim 10, wherein the profile information includes one of a number of completed transactions by the user or a favorite sports team of the user.

12. A computer program product configured to perform the method of claim 1.

13. A system, comprising:
a memory storing information corresponding to an event and event tickets for the event; and
a processor configured to receive information corresponding to one of the event tickets, determine a value of the one of the event tickets, publish at least a portion of the information corresponding to the one of the event tickets and the value of the one of the event tickets, receive an offer for the one of the event tickets and provide the offer to a current owner of the one of the event tickets.

14. The system of claim 13, wherein the processor is further configured to complete a transaction for the one of the event tickets based on the offer.

15. The system of claim 13, wherein the processor is further configured to provide the value of the one of the event tickets to the current owner of the one of the event tickets prior to publishing the at least the portion of the information corresponding to the one of the event tickets and the value of the one of the event tickets.

16. The system of claim 13, wherein the processor is further configured to receive, from the current owner of the one of the event tickets, a counter-offer for the one of the event tickets, provide, to a user that made the offer, the counter-offer and complete a transaction for the one of the event tickets based on the counter-offer.

17. The system of claim 13, wherein the value includes one of a monetary value, a ticket swap value or a point value.

18. The system of claim 13, wherein determining the value of the one of the event tickets is based on at least price information from a secondary marketplace.

19. The system of claim 13, wherein the information includes one of an indication of the event corresponding to the one of the event tickets, a date of the event, a time of the event, a face value of the one of the event tickets, a seat number corresponding to the one of the event tickets, or a section number corresponding to the one of the event tickets.

20. The system of claim 13, wherein the processor is further configured to provide profile information about a user that made the offer to the current owner of the one of the event tickets, wherein the profile information includes one of a number of completed transactions by the user or a favorite sports team of the user.
